(19) United States
(12) Patent Application Publication
(10) Pub. No.: US 2019/0144337 A1
(43) Pub. Date: May 16, 2019

(54) AGGLOMERATION OF FINES OF TITANIUM BEARING MATERIALS

(71) Applicant: ILUKA RESOURCES LIMITED, Perth, Western Australia (AU)

(72) Inventors: Nicholas Glen BERNARD, Capel (AU); John Maxwell BULTITUDE-PAUL, Capel, Western Australia (AU); Roger W. FRANKLIN, Warnbro (AU)

(73) Assignee: ILUKA RESOURCES LIMITED, Perth, Western Australia (AU)

(21) Appl. No.: 16/302,967

(22) PCT Filed: May 19, 2017
(86) PCT No.: PCT/AU2017/050475

§ 371 Date: Nov. 19, 2018

(30) Foreign Application Priority Data
May 19, 2016 (AU) 2016901885

(51) Int. Cl. C04B 18/02; C04B 14/30; C04B 26/28

(52) U.S. Cl. CPC C04B 18/022; C04B 26/285; C04B 26/28; C04B 14/305

(57) ABSTRACT

A micro-agglomerate of fines of a material that is predominantly titanium dioxide in which the fines are bound in the micro-agglomerate by a polysaccharide gum or cellulose derivative and in which the micro-agglomerate has been heated in the temperature range 250-600° C. so that the polysaccharide gum or cellulose derivative is an effective primary binder of the fines when the micro-agglomerate is subjected to high temperature gas flow conditions equivalent to those in the Chloride Process. Also disclosed is a method of agglomerating fines of a material that is predominantly titanium dioxide.

### FIELD OF THE INVENTION

This invention relates generally to the agglomeration of fines of titanium bearing materials and is of particular interest in the agglomeration of materials that are primarily titaniumdioxide, e.g. of rutile and synthetic rutile.

One application of interest is the agglomeration of the fines component of rutile or synthetic rutile feeds to the Chloride Process (often also referred to as the Chloride Pigment Process) for the processing of titanium ores by chlorination, also referred to herein as the pigment chlorination process; it is this context that is the subject of detailed discussion herein.

By synthetic rutile (SR) herein is meant material that is primarily titanium dioxide and has been derived by processing a titanium bearing ore, e.g. ilmenite to enhance the titanium content.

In the context of the specification, “derived by processing” includes materials derived by physical processes, hydrometallurgical processes or pyrometallurgical processes or combinations thereof.

### BACKGROUND OF THE INVENTION

The Chloride Process entails chlorination of a titanium ore feedstock (e.g. rutile, synthetic rutile, ilmenite or titanium slag) with carbon and chlorine gas, giving titanium tetrachloride TiCl₄. The TiCl₄ is purified by distillation, In post treatments, the TiCl₄ can then be oxidised in an oxygen flame or plasma to give pure TiO₂, or reduced, e.g. with Mg, to give titanium metal. The presence of fine material (<100 μm) in the feed to titanium pigment chlorinators is a known problem for the productivity of the Chloride Process. For example, typical synthetic rutile contains 5-10% of fine material which is blown over, often referred to as elutriation, from the titanium pigment chlorinators with little to no conversion to titanium tetrachloride: this can result in significant titanium loses from the chlorinators along with associated high residue disposal costs. As a result, penalty clauses and/or hidden pricing structures based on the SR fines content and chlorinator titanium recovery are typically incorporated in the maximum price chlorinator operators are prepared to pay for their synthetic rutile feed. SR fines thereby typically represent a loss of revenue for the SR producer.

Some mineral sands deposits contain significant quantities of fine ilmenite which if processed into synthetic rutile, is not suitable feedstock for pigment chlorinators.

Prior proposed titanium mineral agglomeration technology has included a process in which a mixture of fine-grained TiO₂-bearing material, bituminous coking coal and a water soluble binder is prepared by coking into composite agglomerated particles. This process was found not to be acceptable because the pigment chlorination process itself is a reductive chlorination and so the carbon in the feed material must be present in a specific proportion to the TiO₂-bearing material, which may not be suited to composite strength development. In addition, the carbon is attacked in the chlorination process and the agglomerate thereby breaks down before complete chlorination occurs, and so fine particle size material is still lost by entrainment in the gas stream.

In another prior proposed process a water emulsion of asphalt is employed as a binder in the formation by extrusion of pellets of fine grain titanium-bearing material. However, this process required a slow curing at 1000° C. to remove water from the pellets and convert organic material to carbon. The curing results in the caking of the binder in the pores and around the grains, forming a good bond; there is no chemical bond between the binder and the titanium-bearing material. As well as curing at 1000° C., this process involved a further step of breaking the extruded material into a size range close to the required feed size.

International patent publication WO 90/010073 discloses a process of agglomerating fine titaniferous material in which the fine mineral is mixed with a binding agent and water to produce an agglomerate, which is then dried and sintered. A wide range of binding agents are suggested but only bentonite and lignosulphonate are specifically exemplified. The sintering step is said to bond the titaniferous particles directly together and to drive off the binder.

U.S. Pat. No. 7,931,886 discloses agglomerated particles, or pellets, of titania slag feed for the Chloride Process, utilising a variety of binders including organic binders. The preferred binder is gelled corn starch but carboxyl-methyl-cellulose in the guise of the commercial product Peridur is also exemplified. Air drying of the pellets, e.g. at 80° C., is favoured, without subsequent calcining or other high temperature treatment, Alternatively, the pellets may be treated at higher temperature, typically at about 160° C. to 200° C. and even 250° C., to obtain drying and hardening of the pellets.

In general, it is desirable that an agglomeration step does not introduce elements into the agglomerates that would have a deleterious effect on downstream processes. Moreover the agglomerates require reasonable green strength (drop test) to minimise breakage during agglomeration and subsequent conveying to the drier, and reasonable dry strength (drop test) and dry crush (or compressive) strength to ensure resistance to breakage during conveying, storage and shipping. In addition, for application to the pigment chlorination process, the agglomerates must have high thermal shock resistance to ensure the agglomerates do not disintegrate when fed to the pigment chlorinators, which operate at temperatures between 900 and 1000° C.

One of the issues with agglomerating SR fines is the particles' high porosity and surface area (1.39 to 2.09 m²/g) which can be affected by the type of ilmenite used to produce the SR.

The use of polysaccharide gums and cellulose derivatives has been described in processes for agglomerating iron ore fines but these disclosures have generally proposed employment of any of a wide range of polysaccharides in conjunction with other materials in a binder system that concludes with firing of the iron ore pellets at high temperatures.

For example, in U.S. Pat. No. 4,751,259 there is proposed a composition for agglomerating iron containing minerals that comprises a water-in-oil emulsion of a water soluble vinyl addition polymer and a polysaccharide. The suggested polysaccharides includes starches, modified starches, cellulose and modified cellulose including carboxymethyl cellulose (CMC), sugars and gums including biochemically synthesised heteropolysaccharides such as xanthan. Although the iron titanium mineral ilmenite is mentioned as an iron ore to which the process is applicable, the examples are limited to the mineral taconite.

U.S. Pat. No. 5,306,327 again focuses on agglomeration of iron ore particles. Here, the binder system comprises primarily modified native starches with a water dispersible polymer as a binding modifier. Water dispersible cellulose derivatives and natural gums including xanthan gum are among the many listed candidates as the binding modifier. In this case, the pellets are fired at 1200-1300° C.

US patent publication US 2002/0035188 proposes an agglomeration preparation step in which the surface of the particulate material is rendered negative prior to adding a polymeric binder selected from a wide range of materials, notably starches, celluloses and cellulose derivatives including CMC, and xanthan gum.

It is an object to the invention to provide micro-agglomerates that are predominantly titanium dioxide and suitable for processes requiring a minimum feed particle size, and, further, to provide a process for agglomerating fines of titanium dioxide bearing materials. It is preferable that the process of the invention does not include a high temperature processing step, i.e. in the region of 1000° C. or higher.

Reference to any prior art in the specification is not an acknowledgment or suggestion that this prior art forms part of the common general knowledge in any jurisdiction or that this prior art could reasonably be expected to be combined with other pieces of prior art by a skilled person in the art.

### SUMMARY OF THE INVENTION

It has been surprisingly found that fines of TiO₂-bearing minerals may be formed into useful micro-agglomerates that exhibit an acceptable green strength, acceptable dry strength and high thermal shock resistance, and that are structurally sustainable in an atmosphere such as that to which they are subjected in the Chloride Process, by employing certain effective polysaccharides, preferably effective polysaccharide gum and cellulose derivatives, as primary binder and heat treating the initial bound micro-aggregates in the temperature range 250-600° C. Of particular interest as binders are xanthan gum, carboxymethyl celluloses (CMCs) and polyanionic celluloses (PACs).

The invention accordingly provides, in a first aspect, a micro-agglomerate of fines of a material that is predominantly titanium dioxide in which the fines are bound in the micro-agglomerate by a polysaccharide gum or cellulose derivative and in which the micro-agglomerate has been heated in the temperature range 250-600° C. so that the polysaccharide gum or cellulose derivative is an effective primary binder of the fines when the micro-agglomerate is subjected to high temperature gas flow conditions equivalent to those in the Chloride Process.

In its first aspect, the invention also provides a particulate material comprising the aforesaid micro-agglomerates of the invention.

The invention further provides, in its first aspect, a method of agglomerating fines of a material that is predominantly titanium dioxide, comprising: forming the fines into micro-agglomerates in which the fines are bound in the micro-agglomerates a polysaccharide gum or cellulose derivative, and heating the micro-agglomerates in the temperature range 250-600° C. so that the polysaccharide gum or cellulose derivative is an effective primary binder of the fines when the micro-agglomerate is subjected to high temperature gas flow conditions equivalent to those in the Chloride Process.

By “primary” binder herein, is meant that the polysaccharide gum or cellulose derivative may be a component of a binder composition having other components for other purposes, but notwithstanding such other components the material principally binding the particles in the micro-agglomerate is primarily composed of polysaccharide gum or cellulose derivative.

By “effective” primary binder is meant that the majority of the micro-agglomerate(s) will survive conveyance and transport, and remain physically intact when subject to high temperature gas flow conditions equivalent to those in the Chloride Process.

Exemplary high temperature gas flow conditions equivalent to those in the Chloride Process are set out herein in Example 4.

The micro-agglomerates may exhibit structure in which each fines particle is bound to at least two other fines particles by a web of the polysaccharide gum or cellulose derivative whereby the polysaccharide gum or cellulose derivative forms a network of webbing firmly binding the particles in the micro-agglomerate.

In a second aspect, the invention provides a micro-agglomerate of fines of a material that is predominantly titanium dioxide in which the fines are bound in the micro-agglomerate by webs that comprise polysaccharide gum or a cellulose derivative, the webs having a respective longitudinally central region of a minimum thickness substantially smaller than the size of the respective bound fines particles.

In its second aspect, the invention also provides a particulate material comprising micro-agglomerates of a material that is predominantly titanium dioxide in which the fines are bound in the micro-agglomerate by webs of a polysaccharide gum or a cellulose derivative, the webs having a respective longitudinally central region of a minimum thickness substantially smaller than the size of the respective bound fines particles.

In its second aspect, the invention provides a method of agglomerating fines of a material that is predominantly titanium dioxide, comprising forming the fines into micro-agglomerates in which the fines are bound by webs of a polysaccharide gum or a cellulose derivative, the webs having a respective longitudinally central region of a minimum thickness substantially smaller than the size of the respective bound fine particles.

By “size” herein in relation to a micro-agglomerate or a particle is meant the circular mesh aperture size through which the micro-agglomerate or particle can pass.

In a third aspect, the invention further provides a Chloride Process in which the titanium dioxide bearing feed material to the process includes micro-agglomerates according to a first and/or second aspect of the invention.

The webs may, for example, be of a minimum thickness in their longitudinally central region in the range 0.1-10 μm, more preferably 0.5-5 μm. At each of its ends, each web may fan out to join the respective fines particles along an extended line of contact. These fanned out portions of the webs may interconnect with other fanned out portions of other webs.

In each aspect of the invention, the polysaccharide gums of particular though not exclusive interest include xanthan gum and the cellulose derivatives of particular though not exclusive interest are a carboxymethyl cellulose (CMC) and a polyanionic cellulose (PAC).

The fines of particular interest are rutile fines and synthetic rutile fines but other fines of interest include those of titanium slag, ilmenite and leucoxene. CMC is a preferred primary binder for producing synthetic rutile or other titanium dioxide micro-agglomerates suitable as a feed for the Chloride Process. High viscosity polyanionic cellulose (PAC-HV) is suitable though less preferred for dry fines, while CMC is particularly preferred for wet fines.

In each aspect of the invention, the micro-agglomerates are preferably formed prior to or simultaneously with said heating in a continuous high shear mixer. A suitable such mixer is the “Flexomix” manufactured by Hosokawa Micron B.V. This mixer consists of a vertical cylindrical chamber enclosing a mixer knife that rotates about a vertical axis at high speeds in the range 1500 to 4500 rpm. The high shear mixer process combines the mixing process with the agglomeration step in a single unit. The high shear mixer produces micro-agglomerates with particle sizes between 100 and 1200 μm.

In a continuous high shear mixer, fines, powdered binder and water are proportionally fed through the top mixer inlets (for the powders) and atomisation nozzles (for the water), into a highly turbulent, circular flow that creates an aerosuspension of the feed materials in the upper part of the mixer, which produces wet agglomerates within a narrow particle size—which is preferred for the subsequent drying process. The residence time in the mixer may typically be about one second and the wet micro-agglomerates are continuously discharged into a fluid bed drier. The design of the fluid bed drier is preferably such as to minimise any post-agglomeration that would result in the production of larger agglomerates.

Preferably, the micro-agglomerates are not prior to their end-use calcined or otherwise heat treated above 600° C. as is common practice, e.g. at around 1000° C., with prior art agglomeration processes. In this instance such treatment is likely to materially degrade the bond provided by the primary binder. The forming step is preferably a cold forming step, i.e. at a temperature between 20° C. and 100°, more preferably between 10 and 70° C. The preferred temperature of said heating step is between 275 and 350° C., and the treatment time at or near the target temperature is preferably in the range 0.1 to 2 hours, more preferably 0.25 to 1 hour.

In one or more embodiments, the forming and heating steps may be effected substantially simultaneously.

The heating step is found to reduce degradation and therefore blow over or elutriation of the micro-agglomerates in a fluidizing column or fluid bed reactor. The heating step may additionally drive off reactive H and/or OH units from the polysaccharide or cellulose structure without otherwise degrading the structure, and thus reduce reactive sites for chlorine to attach to and breakdown the binding webs, further enhancing the survival time of the micro-agglomerates in the Chloride Process.

Preferably, the micro-agglomerates are of a size between 125 and 5,000 μm, more preferably between 125 and 1,500 μm.

The fine particles bound in the micro-agglomerates may typically be of a size in the range 10-250 μm, more preferably 20-125 μm.

The proportion of polysaccharide gum or cellulose derivative is preferably in the range 2-10% with respect to the combined weight of the fines and polysaccharide gum, more preferably 3-6%.

Optimal moisture content is typically in the range 6-25% with respect to the combined mass of fines and water and is sensitive to the agglomeration technique. For example agglomerating the fines by simply forming the mass by hand requires moisture contents in the range 20-25%, whereas agglomerating in a high shear mixer requires moisture contents in the range 6 to 17%.

As mentioned, the polysaccharide gums of particular interest include xanthan gum. It is known that xanthan gum exhibits mutual viscosity synergy and thus other polysaccharide gums exhibiting a similar mutual property may also be of interest.

The polysaccharide gum xanthan gum is a polysaccharide secreted by the bacterium Xanthomonas Campestris, and is composed of pentasaccharide repeat units comprising glucose, mannose and glucuronic acid in the molar ratio 2.0:2.0:1.0.

The polysaccharide cellulose derivative CMC is a semi-flexible anionic cellulose ether polymer that is produced by reacting alkali cellulose with sodium monochloroacetate under rigid controlled conditions. It is a chemical derivative of cellulose where some of the hydroxyl groups (—OH) are substituted with carboxymethyl groups (—CH₂COOH), while PAC is a kind of anionic cellulose ether of high purity and high degree of substitution, prepared with natural cellulose through chemical modification. The difference between the CMC and PAC production processes is in the radicalisation step and the high degree of substitution in PAC.

### BRIEF DESCRIPTION OF THE DRAWINGS

FIGS. 1 and 2 are representative scanning electron microscope (SEM) images of portions of a synthetic rutile micro-agglomerate formed according to the procedure in Example 1, in which the binder is CMC, viewed prior to any thermal shock test as described herein, involving sudden heating to 1000° C. to simulate the chlorination process where ambient temperature feed is introduced into a chlorinator operating at 900-1000° C.;

FIGS. 3 and 4 are representative scanning electron microscope (SEM) images of portions of a synthetic rutile micro-agglomerate formed according to the procedure in Example 1 in which the binder is CMC, viewed after a thermal shock test as described herein and immediately above;

FIG. 5 is a graphical representation of the particle size distribution (PSD) for a number of micro-agglomerate samples formed according to the procedure in Example 2, and for the original synthetic rutile fines from which they were formed;

FIG. 6 is a graphical representation of the particle size distribution (PSD) for the same samples as for FIG. 5 but after thermal shock testing of the samples;

FIGS. 7 to 9 are respective pairs of SEM images of portions of the dry and heated micro-agglomerates formed according to the procedure in Example 2 for the binders xanthan gum, high viscosity PAC (PAC-PV) and CMC respectively;

FIG. 10 is a graphical representation of the particle size distribution (PSD) for a number of micro-agglomerate samples formed according to the procedure in Example 3, and for the original synthetic rutile fines from which they were formed;

FIG. 11 is a graphical representation of the particle size distribution (PSD) for the same samples as for FIG. 10 but after thermal shock testing of the samples;

FIGS. 12 to 14 are respective pairs of SEM images of portions of the dry and heated micro-agglomerates formed according to the procedure in Example 3 for the binders xanthan gum, high viscosity PAC (PAC-PV) and CMC respectively;

FIG. 15 is a set of SEM images corresponding to FIG. 14, i.e. for CMC binder, but with a higher loading of binder; and

FIG. 16 is an SEM image of a micro-agglomerate after heating at 300° C., one of the samples tested in Example 4.

### EXAMPLE 1

Synthetic rutile fines (≤125 μm) were formed into micro-agglomerates, i.e. pelletised, employing small circular, flat top and bottom, plastic moulds with sloping slides to facilitate removal of the pellets. The resulting pellets had the approximate dimensions 8 mm deep, maximum diameter 17 mm, minimum diameter 15 mm. The mean weight of dried pellets was 2.6 g±0.2 g.

A variety of binders were tested. The method of mixing depended on the type of binder being used. In the case of powder binders, the required amount of powder was first thoroughly mixed with 100 g synthetic rutile (SR) fines in a small plastic mixing bowl. Water (30 g) was then added to this mixture whilst stirring. The final mixture was adjusted, if necessary, by adding water in incremental amounts until the mixture was judged to have the required consistency to form satisfactory pellets. Typically, additional water was in the range of 1-2 g per 100 g SR fines and was only required when forming pellets with 4 to 8% binder.

In the case of liquid binders, the required amount was weighed into the clean mixing bowl, sufficient water added to bring the total amount of water plus binder to 30 g and then the SR fines (100 g) added with continuous mixing. It was found that adding 30 g water plus the liquid binder invariably resulted in mixtures that were too wet to form satisfactory pellets.

Even if the amount of water in the liquid binders was calculated such that the total amount of water added was 30 g per 100 g fines the mixture was generally too wet. In several instances, especially at higher binder loadings, the amount of water had to be reduced to well below the calculated amount required in order to obtain satisfactory pellets.

The pellets were formed by scooping up sufficient of the blended material to overfill the mould and then the material was compressed into the mould using a metal spatula. Excess material was scraped off the mould using the edge of the spatula and the pellet discharged from the mould with a sharp tap.

Ease of discharge from the mould was partly a function of the binder. Some binders made the pellets very easy and clean to discharge, others caused difficulty with the material not discharging easily or breaking in the mould. As a general rule pellets with good green strength were easier to work with than those with little or no green strength.

Pellets were placed in aluminium foil trays and oven dried at 110° C. for 1 hour. After removing from the oven, the pellets were allowed to cool and left for a minimum of 2 hours before being tested. Dry strength was monitored over a period of 7 to 10 days after the initial testing for any changes to dry strength.

Green strength and dry strength were assessed using a drop test. Green strength is useful for minimising breakage during agglomeration and subsequent conveying to the drier, while an adequate dry strength ensures resistance to breakage during conveying, storage and shipping. The method consisted of dropping ten pellets from a height of 50 cm onto a steel plate. The number of pellets surviving the drop was recorded and the surviving pellets dropped again. The number of pellets surviving the second drop was recorded and the process repeated for a third time.

Pellets used in the green strength test were discarded.

Crush strength, also significant for resistance to breakage during storage and shipping, could not be measured accurately. A qualitative scale was adopted as follows:

0 No strength—pellets disintegrate with little or no applied force

1 Very poor—pellets easily crushed by hand

2 Pellets can be crushed by hand with some difficulty

3 Pellets cannot be crushed by hand

The reporting of the crush strength, particularly the distinction between 1 and 2 was somewhat arbitrary. It was intended as a guide to the relative performance of the different binders after drying. The significance of crush strength is mainly in relation to stockpiling of micro-agglomerates.

### Results

Xanthan Gums

Three grades of xanthan gum were supplied. The three products differed with respect to purity, the higher the purity the more expensive the product. On paper the best product (for oilfield use) is Xanthan CY. This product was tested at 2, 4 and 8%. The other oilfield xanthan gum (Xanthan PY) and the cheapest grade (Xanthan TJ) were only tested at 2% addition.

The results are set out in Table 1.

All three products mixed easily with the SR fines (similar to Guar gum). At highest rate of addition (8%) the mixture was difficult to work with.

There was no observable difference between the three products at 2% addition either qualitatively or in the drop test results.

TABLE 1

| | | | | |
|---|---|---|---|---|
| | Drop | Drop | | |
| | Strength | Strength | Crush | |
| % Binder | Green | Oven Dried | Strength | Notes |

Xanthan Gum CY

| | | | | | | | | |
|---|---|---|---|---|---|---|---|---|
| 2 | 10 | 10 | 10 | 10 | 10 | 10 | 3 | |
| 4 | 10 | 10 | 10 | 10 | 10 | 10 | 3 | Extra water |
| | | | | | | | | required (1%) |
| 8 | 10 | 10 | 10 | 10 | 10 | 10 | 3 | Extra water |
| | | | | | | | | required (2%) |

Xanthan Gum PY

| | | | | | | | |
|---|---|---|---|---|---|---|---|
| 2 | 10 | 10 | 10 | 10 | 10 | 10 | 3 |

Xanthan Gum TJ

| | | | | | | | |
|---|---|---|---|---|---|---|---|
| 2 | 10 | 10 | 10 | 10 | 10 | 10 | 3 |

Other binders tested in a similar fashion included cellulose gum, technical grade carboxymethyl cellulose (CMC), high and low viscosity polyanionic cellulose (PAC), hydroxymethyl/hydroxypropyl cellulose, sodium carboxymethyl cellulose, water soluble and raw starches, partially hydrolysed polyacrylic acid, acrylic-styrene polymer, styrene-acrylic co-polymer emulsion, vinyl acrylic emulsion, PVA (polyvinyl acetate), ferric chloride, ferrous chloride and sodium silicate.

The potential binders that were found to give good green strength, good dry strength, and good crush strength comprised only natural products or derivatives of natural products. These were:
The polysaccharide gums guar gum and xanthan gum
The cellulose derivatives cellulose gum (sodium carboxymethyl cellulose—CMC), technical grade CMC and polyanionic cellulose
A number of hydroxymethyl/hydroxypropyl cellulose derivatives.

None of the synthetic polymers tested gave acceptable green strength.

The micro-agglomerates found satisfactory from the perspective of green strength, dry strength and dry crush strength, i.e. the micro-agglomerates made with the binders listed immediately above, were further tested for their high temperature (thermal) shock resistance, in order to determine their suitability as micro-agglomerates for the pigment chlorination process (i.e. the “Chloride Process” or “Chloride Pigment Process”). For this purpose, the micro-agglomerates were subjected to a thermal shock test by being “instantaneously” heated in a muffle furnace to 1000° C. for 15 minutes, to simulate the chlorination process where ambient temperature feed is introduced into a chlorinator operating at 900-1000° C. To simulate the reducing conditions prevalent in a chlorinator, the pellets were covered with a layer of char fines and fired in a closed crucible.

The number of pellets that cracked and/or exploded upon thermal treatment was considered a measure of the thermal shock resistance. On cooling, the intact pellets were subjected to a compression test to provide an indication of hot strength.

The results of the high temperature thermal shock tests are set out in Table 2.

TABLE 2

| | Cellulose | | | | | | | | | PAC - Low | | PAC - High | |
|---|---|---|---|---|---|---|---|---|---|---|---|---|---|
| Binders | Gum | | Guar Gum | | Xanthan Gum | | | CMC | | Viscosity | | Viscosity | |
| Binder | 2 | 4 | 2 | 4 | 2 | 4 | 8 | 4 | 8 | 4 | 8 | 4 | 8 |
| Addition | | | | | | | | | | | | | |
| (%) | | | | | | | | | | | | | |
| Average | 360 | 1660 | <30 | 200 | 1110 | >2000 | >2000 | >2000 | >2000 | 350 | 1725 | 1055 | 1860 |
| Crush | | | | | | | | | | | | | |
| Strength | | | | | | | | | | | | | |
| (g) | | | | | | | | | | | | | |

It will be seen that only the xanthan gum (>2%), cellulose gum (4%), CMC (≥4%) and low and high viscosity PAC (8%) demonstrated adequate high temperature thermal shock resistance, i.e. greater than 1000 g.

Surface regions of a selected pellet or micro-agglomerate were then viewed in a scanning electron microscope. A cross section was removed by sectioning the pellets with a scalpel. The cross section was placed with the newly-exposed side facing upwards on a double sided carbon tab and held stable with silver DAG. The sample was not carbon coated. The sample was analysed using a Carl Zeiss EV050 scanning electron microscope (SEM) fitted with an Oxford INCA X-Max energy dispersive spectrometer (EDS).

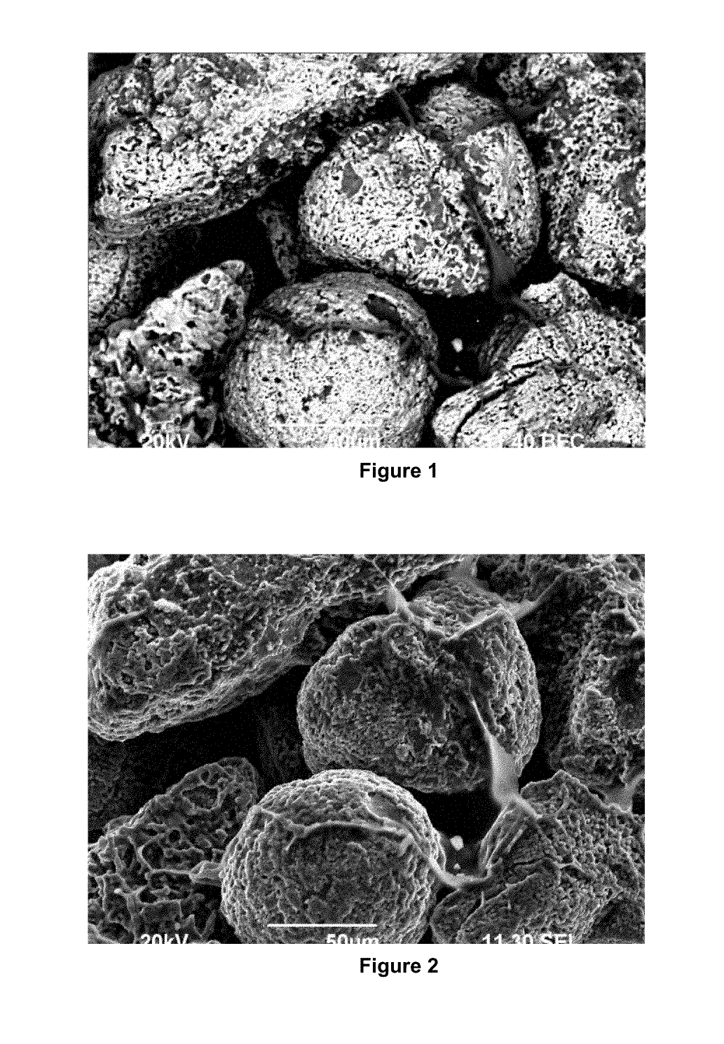

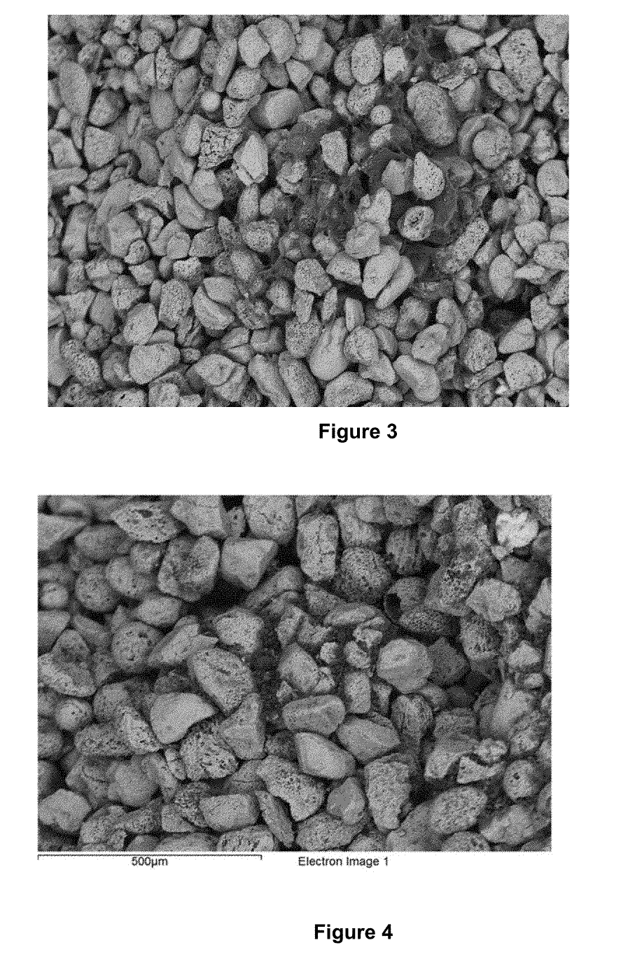

. Representative SEM images are appended hereto as FIG. 1 to 4. A 50 μm or 500 μm scale is provided on each image. FIGS. 1 and 2 are for an SR microaggregate in which the binder is CMC, viewed prior to the thermal shock test. FIGS. 3 and 4 are for an SR microaggregate in which the binder is CMC, viewed after the thermal shock test.

It will be seen that in all four images the particles of synthetic rutile are each bound to two or more other particles by bridges or webs of the CMC binder whereby the CMC binder forms a network of webbing firmly binding the particles in the micro-agglomerate. Each web is less than 5 μm in minimum thickness, and at each end fans out to join the respective particle along an extended line of contact, i.e. a curving peripheral surface line. Some of these fanned out web portions join along the particle surfaces to one or more other fanned out portions of other webs.

It is postulated that the webs visible in the SEMs may form strong bonds with the particles by being firmly locked into the multiple pores of the particles in the interface zone.

### EXAMPLE 2

Synthetic rutile fines (≤105 μm) were formed into dry micro-agglomerates, i.e. pelletised, using a Hosokawa Alpine Gear Pelletiser. The dry pellets produced were spherical in form with a particle size in the broad range 100-1000 μm.

In this instance, adopting the results of Example 1, only three binders were used to produce respective sample sets of agglomerates for further testing. These binders were xanthan gum, sodium carboxymethyl cellulose (sodium CMC) and a high viscosity polyanionic cellulose (PAC-HV). The added proportion of binder was 4%.

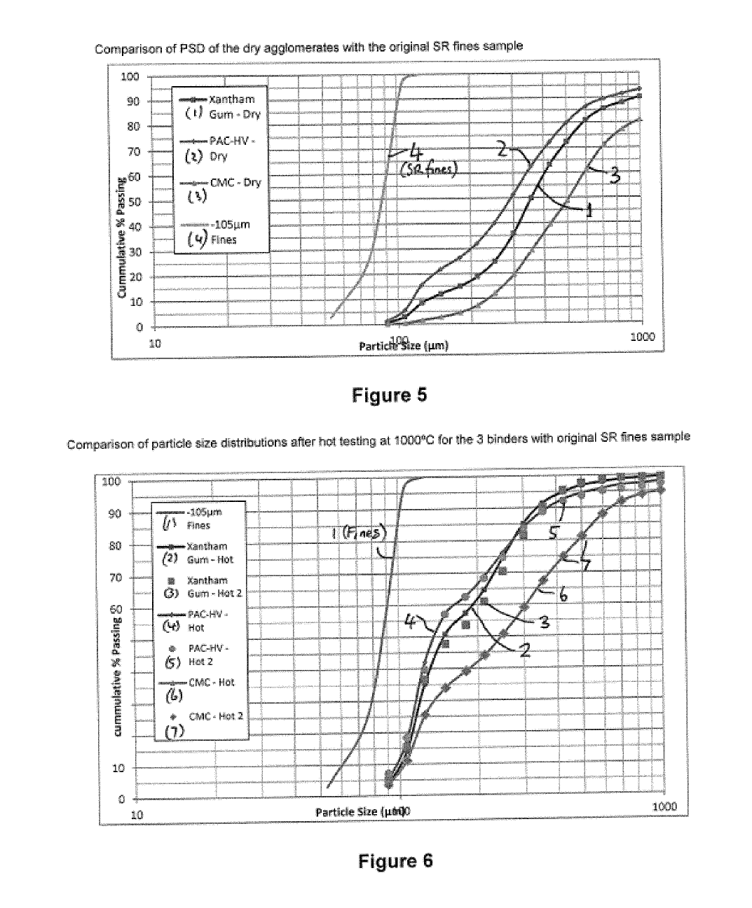

FIG. 5 depicts the particle size distribution (PSD) for each sample, i.e. the cumulative percentage of particles passing each size fraction (for each binder) compared to the original SR fines sample. It will be seen that there has been a dramatic increase in the PSD for all agglomerated samples compared to the SR fines. The CMC-binder agglomerates had the greatest increase in particle size followed by Xanthan gum and PAC-HV. Visually the CMC agglomerates included a significant quantity of soft particles that were >1 mm in size.

The hot testing of the agglomerates used the same procedure previously used for the hand formed pellets, namely weighed amounts (100 g) of agglomerates were placed in small ceramic crucibles which were then covered with powdered carbon to prevent oxidation during heat treatment. Ceramic lids covered the crucibles and the crucibles were then placed into the pre-heated muffle furnace at 1000° C. for 15 minutes (timed from when the temperature of the furnace recovered to 1000° C.). The PSD of the heat treated agglomerates (FIG. 6) indicates that some deterioration of the agglomerates occurred, which resulted in a reduced PSD when compared to the dry as received agglomerates, for each binder.

XRD traces of the dry (as received) and heat treated agglomerates showed that some oxidation occurred during the hot testing of the agglomerates. The phase structure of the dry agglomerates had been transformed from mostly reduced rutiles (TiO₂₋ₓ) to rutile (TiO₂). This was also confirmed from the carbon contents of the dry and heat treated agglomerates, which showed that ˜50% of the carbon had been lost from the agglomerates, as shown in Table 3.

TABLE 3

| | Dry Agglomerate | Heat Treated Agglomerate |
|---|---|---|
| Binder | Carbon Content (%) | Carbon Content (%) |
| Xanthan Gum (R1) | 1.86 | 0.81 |
| PAC-HV (R2) | 1.68 | 0.72 |
| CMC (R3) | 1.62 | 0.84 |

The partial oxidation of the agglomerates may have caused the loss in strength of the agglomerates indicated by the reduced particle size distributions observed for all binders.

The hot tests were repeated with similar results to the first hot test. The PSD for each binder was almost identical to the first hot test results shown in FIG. 6. The XRD traces indicated the structure had partially oxidised to rutile with some reduced rutile phases still present.

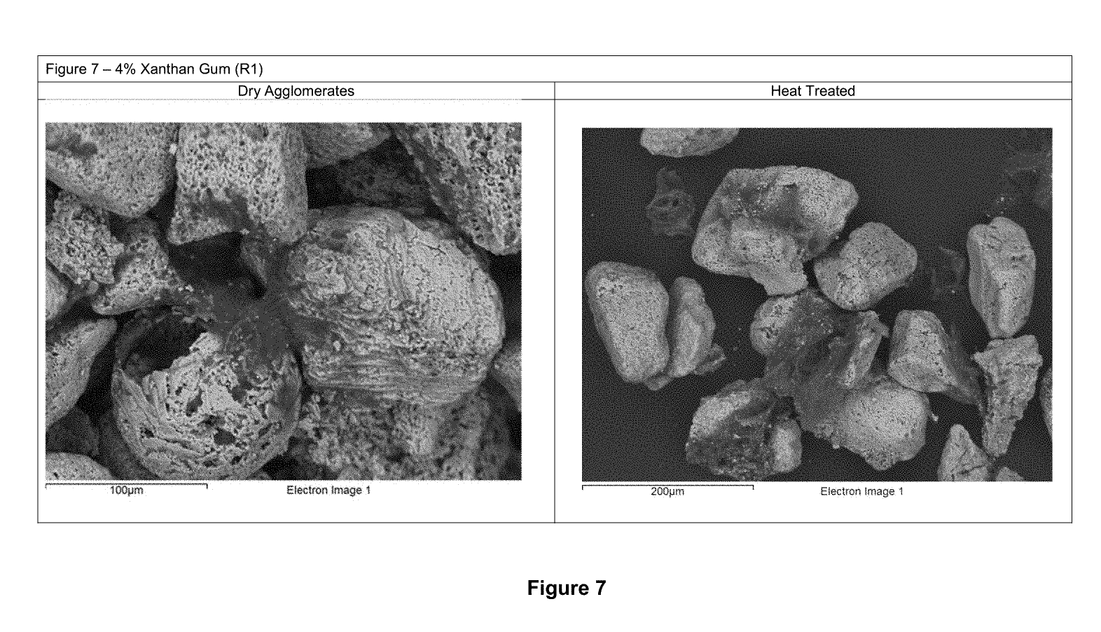

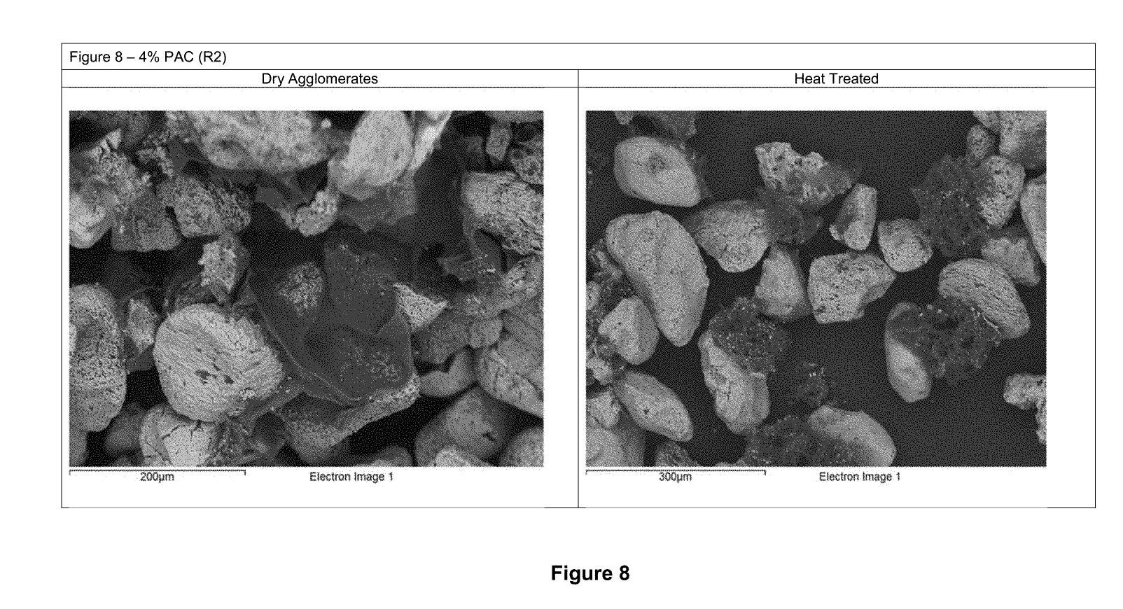

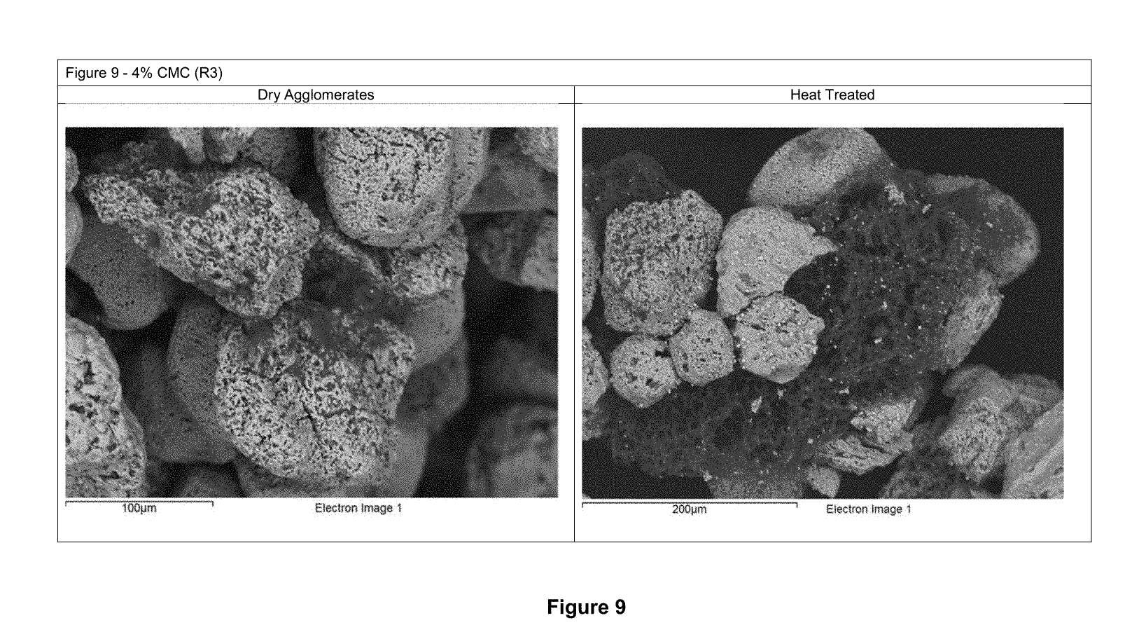

FIGS. 7, 8 and 9 are respective pairs of SEM images of the dry and heated agglomerates for the binders xanthan gum, PAC-PV and CMC respectively. It will be seen that the PAC and CMC binders of FIGS. 8 and 9 have “coked” into a more spongy appearance than the xanthan gum of FIG. 7.

Table 4 indicates the spectrum analysis of the binder phases in the SEMs of FIGS. 7, 8 and 9. The analysis indicates the presence of C, O, Na and CI in the binder phases, ranging from trace (<5% Full Scale Spectrum—Tr), to minor (5-50% Full Scale Spectrum—Min), to major (50-100% Full Scale Spectrum—Maj). Most of the oxygen, sodium and chlorine were removed when the agglomerates were heat treated. The removal of oxygen is associated with decomposition of the various binders which removes the —OH from the cellulose structures.

TABLE 4

| Agglomerate | Carbon | Oxygen | Sodium | Chlorine |
|---|---|---|---|---|
| R1 - Xanthan Gum (dry | Maj | Maj | Maj | 0-Tr |
| agglomerate) | | | | |
| R1 - Xanthan Gum (heat treated) | Maj | 0 | 0 | 0 |
| R2 - PAC-HV (dry | Maj | Maj | Maj | Tr |
| agglomerate) | | | | |
| R2 - PAC-HV (heat treated) | Maj | Tr | Tr | 0 |
| R3 - CMC (dry agglomerate) | Maj | Maj | Min | Min |
| R3 - CMC (dry agglomerate) | Maj | 0 | Tr | Tr |

The maintenance of the carbon is consistent with the reducing atmosphere, and no doubt contributes to maintaining the integrity of the web network (now predominantly carbon webs) after heat treatment: a crucial property for the utility of the micro-agglomerates in the Chloride Process.

The conclusion from Example 2 is that all three binders produced titanium dioxide agglomerates suitable as a feed for the Chloride Process.

The hot testing of the agglomerates resulted in some deterioration of the agglomerates but still resulted in 85 to 93% of the agglomerates having a particle size >100 μm. This is only an indicative test and does not directly relate to conditions in a chlorinator. The deterioration of the agglomerates could be a result of the partial oxidation of the agglomerates during the hot testing or insufficient binder. Oxidation would not occur in a chlorinator.

A slightly higher binder addition (˜6%) might be expected to increase the agglomerates hot strength.

### EXAMPLE 3

Synthetic rutile fines (≤125 μm) were formed into dry micro-agglomerates, i.e. pelletised at Hosokawa's Testing Facility located at Doetinchem in the Netherlands. The test used a Hosokawa continuous FX-160 High Shear Mixer and batch fluid bed drier. The dried pellets produced from the equipment were spherical in form with a particle size in the broad range 100-1000 μm.

In this instance, adopting the results of Examples 1 and 2, only three binders were used to prove the agglomeration process using the high shear mixer and to provide sufficient micro-agglomerate samples for further test work, namely the micro-agglomerate performance in laboratory scale chlorination equipment. These binders were xanthan gum, sodium carboxymethyl cellulose (sodium CMC) and high viscosity polyanionic cellulose (PAC-HV). The added proportion of binder was increased from the laboratory scale tests (Example 2) of 4% to 6%. Two higher CMC binder additive tests were also completed, namely 6.6 and 8.8%. In total 9 separate tests were completed which varied the binder type, moisture content of the mixer discharge, binder addition rate (CMC only), dry and moist SR fines. The agglomeration results are indicated in the Table 5.

TABLE 5

| | | | | | | Max. | | | | | |
|---|---|---|---|---|---|---|---|---|---|---|---|
| | | | | | Max. | Air | Moisture | | Product | | |
| | SR | | Binder | Water | Product | Inlet | ex- | Moisture - | Bulk | Fines <125 | |
| Run | Fines | Binder | Amount | Addition | Temp. | Temp. | Flexomix | Product | Density | μm | d₅₀ |
| No. | (kg/h) | Type | (kg/h) | (kg/h) | ° C. | ° C. | (%) | (%) | (kg/m³) | (%) | (μm) |
| 1 | 500 | CMC | 32 | 30 | 80 | 100 | 6.3 | 0.5 | 987.4 | 32.2 | 158 |
| 2 | 500 | CMC | 32 | 70 | 65 | 150 | 12.5 | 0.5 | | 8.8 | 321 |
| 3 | 500 | CMC | 32 | 75 | 65 | 150 | 13.2 | 0.6 | 1020 | 14.7 | 279 |
| 4 | 500 | Xanthan Gum | 32 | 25 | 65 | 150 | 4.9 | 0.8 | 1031.9 | 34.8 | 161 |
| 5 | 500 | PAC-HV | 32 | 25 | 65 | 180 | 4.9 | 0.4 | 801.1 | 30.6 | 204 |
| 6 | 500 | PAC-HV | 32 | 35 | 70 | 150 | 6.0 | 0.6 | 730.1 | 14.7 | 308 |
| 7 | 500 | CMC | 32 | 100 | 65 | 165 | 14.9 | 0.3 | 915.0 | 3.9 | 386 |
| 8 | 500⁽¹⁾ | CMC | 32 | 40 | 65 | 165 | 15.5 | 0.6 | 955.0 | 7.4 | 329 |
| 9 | 500⁽¹⁾ | CMC | 43.5 | 40 | 60 | 168 | 16.0 | 0.8 | 895.0 | 4.4 | 374 |

⁽¹⁾Fines contained 10% moisture

For each test, metered rates of SR fines, binder and water was added to the high shear mixer, which operated at 3000 rpm mixer speed with +2° mixer knife setting. The residence time in the mixer is approximately 1 second. The wet agglomerated mix was discharged into the fluid bed drier where the micro-agglomerates were batched dried until the agglomerate bed temperature reached 60° C. The micro-agglomerates were then discharged from the drier, sampled and sieve analysis and bulk density were measured.

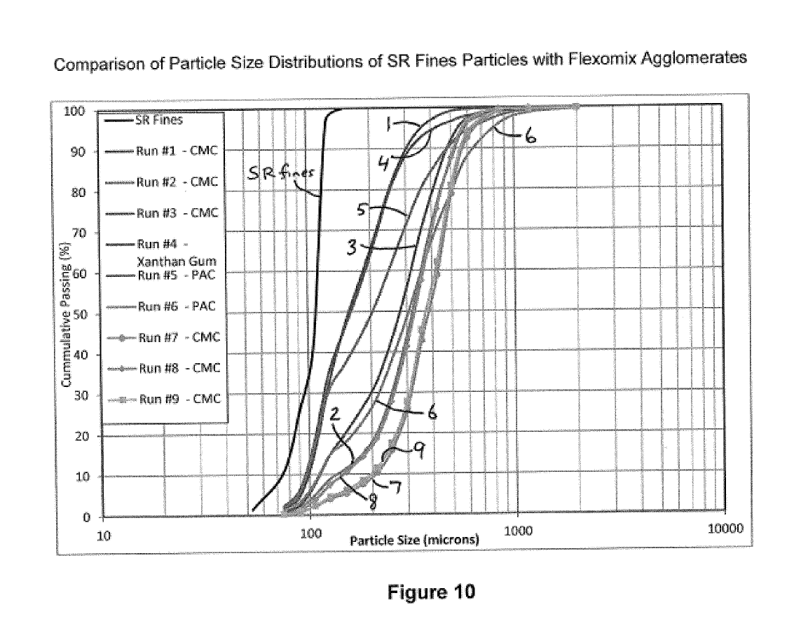

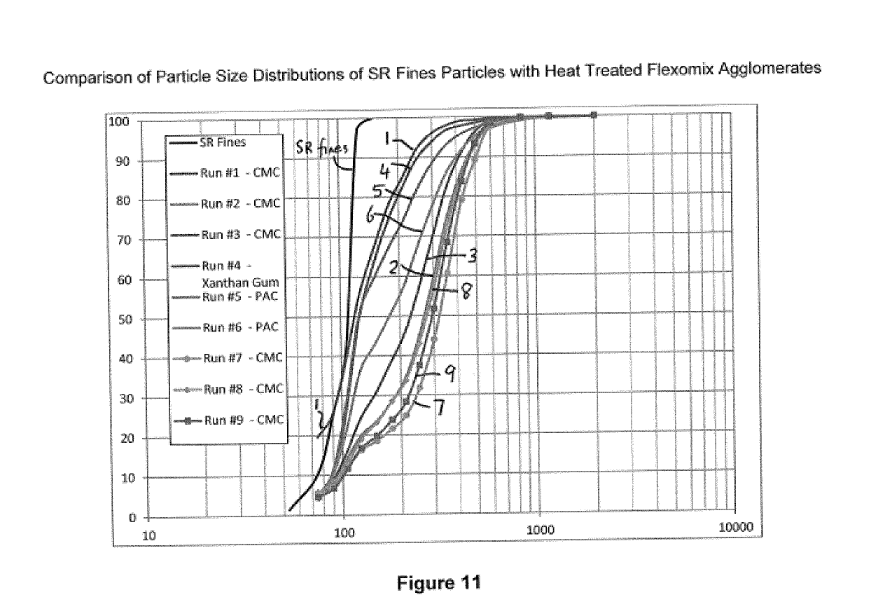

FIG. 10 depicts the particle size distribution (PSD) for each sample, i.e. the cumulative percentage of particles passing each size fraction (for each binder) compared to the original <125 μm SR fines feed. It will be seen that there been a dramatic increase in the PSD for all agglomerated samples compared to the SR fines. The CMC and PAC-HV binder agglomerates had the greatest increase in particle size while Xanthan gum performed the worst under the test conditions. The moisture content during agglomeration had a significant impact on the Flexomix performance based on the quantity of micro-agglomerates that had <125 μm in particle size. The best results from the Flexomix trial test conditions achieved “fines” values of <10% of the agglomerate weight with a particle sizes <125 μm. Increasing the CMC binder addition rate from 6 to 8.8% for the wet SR fines slightly improved the dry agglomerate results but not when compared to the lower addition rate made to the dry SR fines.

The hot testing of the agglomerates used the same procedure previously used in the preceding examples, namely weighed amounts (100 g) of agglomerates were placed in small ceramic crucibles which were then covered with powdered carbon to prevent oxidation during heat treatment. Ceramic lids covered the crucibles and the crucibles were then placed into the pre-heated muffle furnace at 1000° C. for 15 minutes (timed from when the temperature of the furnace recovered to 1000° C.). The hot testing of the agglomerates resulted in some deterioration of the agglomerates (FIG. 11 and Table 6) but still resulted in 86 to 90% of the agglomerates having a particle size >100 μm for the best results under these test conditions (CMC). This is only an indicative test and does not directly relate to conditions in a chlorinator. The deterioration of the agglomerates could be a result of the partial oxidation of the agglomerates during the hot testing or insufficient binder. Similar to Example 2, the XRD traces indicated that some oxidation of the agglomerates occurred during the heat treatment testing, which may have had an impact on the PSD deterioration of the heat treated agglomerates.

TABLE 6
comparison of the fines content and d₅₀ (μm) between the dried and heat
treated agglomerates

| | | | | Heat Treated | |
|---|---|---|---|---|---|
| | | Dry Agglomerates | | Agglomerates | |
| | | Fines | | Fines | |
| | Binder | <125 μm | | <125 μm | |
| Run No. | Type | (%) | d₅₀ (μm) | (%) | d₅₀ (μm) |
| 1 | CMC | 32.2 | 158 | 55.5 | 119 |
| 2 | CMC | 8.8 | 321 | 20.0 | 268 |
| 3 | CMC | 14.7 | 279 | 24.5 | 227 |
| 4 | Xanthan | 34.8 | 161 | 50.1 | 125 |
| | Gum | | | | |
| 5 | PAC-HV | 30.6 | 204 | 50.8 | 124 |
| 6 | PAC-HV | 14.7 | 308 | 36.3 | 177 |
| 7 | CMC | 3.9 | 386 | 16.3 | 320 |
| 8 | CMC | 7.4 | 329 | 19.1 | 276 |
| 9 | CMC | 4.4 | 374 | 16.8 | 294 |

Table 7 indicates the SEM spectrum analysis of the binder phases for each of the nine test runs. The analysis indicates the presence of C, O, Na and Cl in the binder phases as defined in Example 2. Most of the oxygen, sodium and chlorine were removed when the agglomerates were heat treated leaving carbon rich “filaments” which bind the particles. The removal of oxygen is associated with decomposition of the various binders which removes the —OH from the cellulose structures. These results are consistent with those observed in Example 2.

Increasing the CMC binder addition rate from 6.6 to 8.8% for the wet SR fines slightly improved the heat treatment results, but not when compared to the lower addition rate made to the dry SR fines.

TABLE 7
SEM spectral analysis of the binder phases for the dry and heat treated agglomerates

| Run | Binder | Dry Agglomerates | | | | Heat Treated Agglomerates | | | |
|---|---|---|---|---|---|---|---|---|---|
| No. | Type | Carbon | Oxygen | Sodium | Chlorine | Carbon | Oxygen | Sodium | Chlorine |
| 1 | CMC | Maj | Maj | Min | Min | Maj | Tr | 0 | 0 |
| 2 | CMC | Maj | Maj | Min | Min | Maj | 0-Tr | 0 | 0 |
| 3 | CMC | Maj | Maj | Min | Min | Maj | 0-Tr | 0 | 0 |
| 4 | Xanthan Gum | Maj | Maj | Min | Tr | Maj | 0 | 0 | 0 |
| 5 | PAC-HV | Maj | Maj | Min | Tr | Maj | 0 | 0 | 0 |
| 6 | PAC-HV | Maj | Maj | Min | Tr | Maj | 0-Tr | 0 | 0 |
| 7 | CMC | Maj | Maj | Min | Min | Maj | Tr | 0 | Tr |
| 8 | CMC | Maj | Maj | Min | Min | Maj | 0 | 0 | Tr |
| 9 | CMC | Maj | Maj | Min | Min | Maj | Tr | 0 | 0 |

The maintenance of the carbon is consistent with the reducing atmosphere, and no doubt contributes to maintaining the integrity of the web network (now predominantly carbon webs) after heat treatment: a crucial property for the utility of the micro-agglomerates in the Chloride Process.

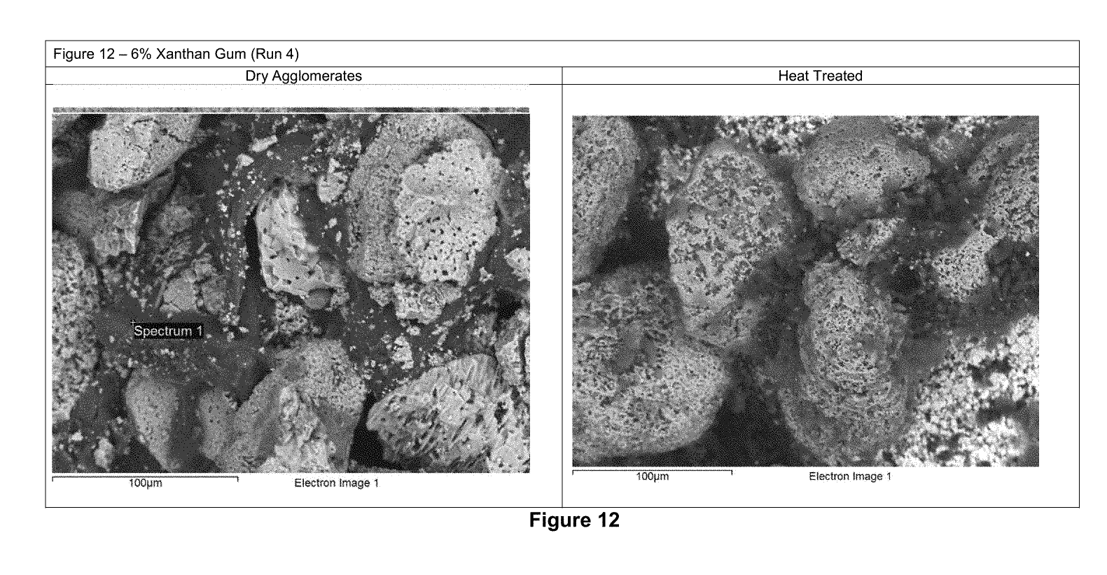

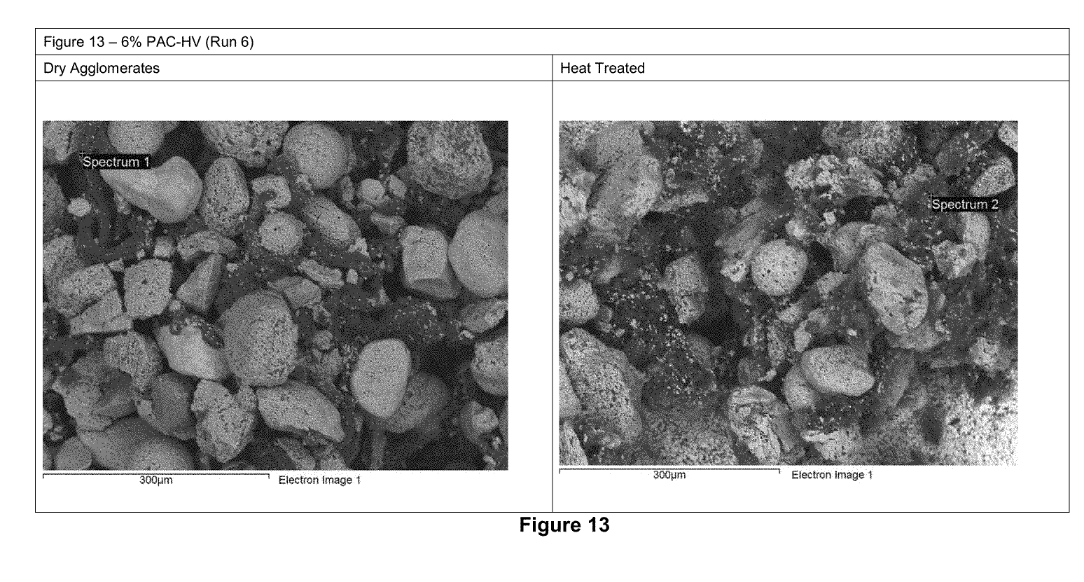

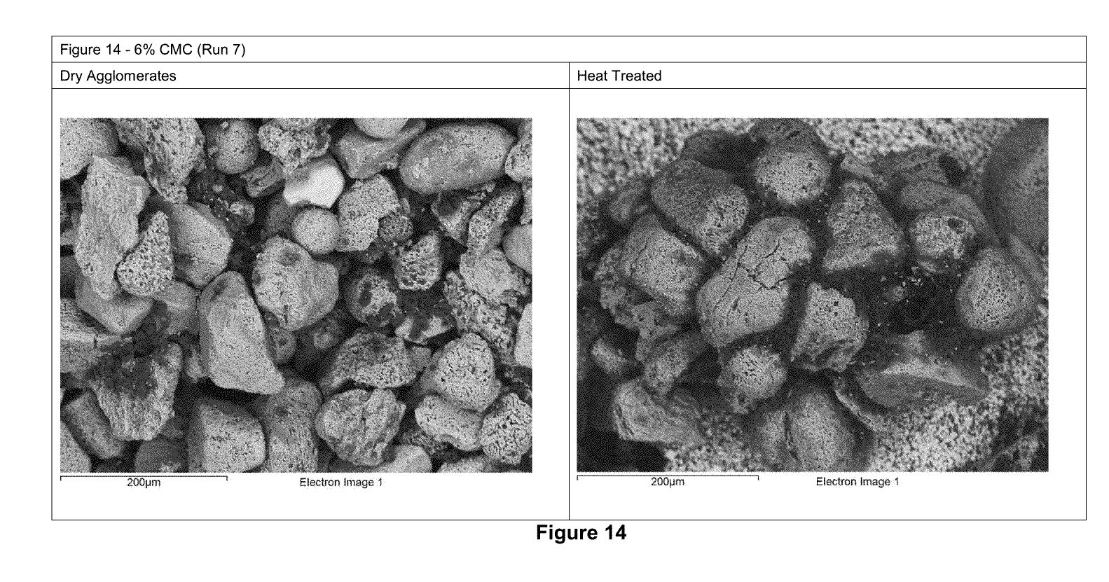

FIGS. 12, 13 and 14 are respective pairs of SEM images (for selected tests) of the dry and heated agglomerates for the binders; xanthan gum, PAC-HV and CMC respectively. It will be seen that the PAC-HV and CMC binders of FIGS. 13 and 14 have “coked” into a more spongy appearance than the xanthan gum of FIG. 12, which indicates a more “dispersed” structure.

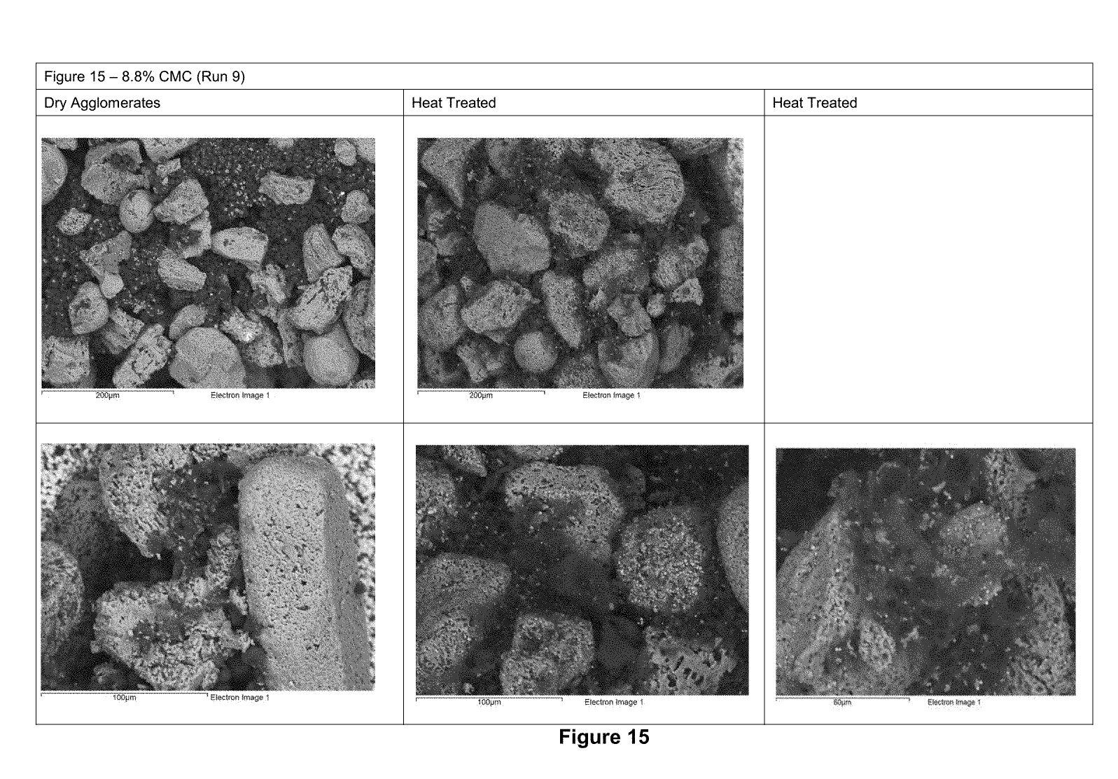

The other interesting observation is that the CMC binder has “behaved” differently to the previous laboratory test in that the binder in the dry agglomerates was rarely seen as the “filament” or web type structure previously observed (FIGS. 1 to 4) and more like small particles coalesced together between the SR fines particles (FIG. 15). Mixtures of “filaments” or webs and particles were also observed, which when heat treated remained as individual filaments/webs or particles respectively. The moisture content of the agglomerate post mixer also appeared to have an impact on the binder structure, at low moisture contents (<13.2%) only individual binder particles were observed while >13.2% a mixture of individual and “filaments” were observed. This feature was not observed in the laboratory mixer tests (Example 2) which produce agglomerates with 14.8% moisture content. Even at higher moisture contents of 16% (FIG. 15) for the Flexomix trials the individual binder particles persisted and may be a result of continuous mixing (˜1 second residence time) compared to the batch laboratory mixer, which was considerably longer.

The conclusions from Example 3, for the test conditions studied, are that CMC and to a lesser extent PAC-HV binders would be suitable to produce titanium dioxide (SR) agglomerates suitable as a feed for the Chloride Process. CMC is the only binder that can be used to agglomerate wet SR fines.

### EXAMPLE 4

Synthetic rutile CMC-bound micro-agglomerates produced in accordance with Example 3 were tested for elutriation in an experimental environment of high temperature gas flow conditions, intended to mimic, i.e. be equivalent to, those in a titanium pigment chlorinator of the Chloride Process. Samples that were respectively (1) not heat treated, (2) and (3) heat treated at 300° C. and 600° C. for 30 minutes at the respective target temperature, and (4) fired at 1000° C. (as in the earlier described hot testing procedure) were subjected to elutriation tests that also employed a structural synthetic rutile sample and synthetic rutile fines used to produce the micro-agglomerates as references.

In the elutriation test, around 600 g of agglomerates were placed in a fluidizing column with ID 80 mm. The setup was heated to 1000° C. and fluidized with N₂ or Ar at a superficial gas velocity of 0.22 m/s (at 1000° C.). No Cl₂ or CO or particulate carbon was used in this test. Fine ore particles elutriating from the bed were captured in the off-gas vent and labelled as blowover. After 30 min at 1000° C., the test was terminated and the sample allowed to cool. The initial and final bed masses, and captured blowover, were recorded. As stated, these high temperature gasflow conditions are equivalent to those in the Chloride Process.

Two sets of numbers were used to calculate elutriation losses: the captured blowovers, and the difference between the initial and final bed masses. Theoretically these two numbers should give the same result. The difference in bed masses is however usually a bigger number. After ruling out the probability of mass loss due to reactions at the experimental conditions, the actual elutriation losses were assumed to be within the range set by the blowover and bed difference.

In the case of micro-agglomerates that contain binder, which (partially) burns off during the test, calculating the actual elutriation losses is a bit more complicated. It is unknown how much of the binder burned off during the pre-heat treatment (where this was done), and/or during the elutriation test. This is dealt with by giving two numbers for both the bed losses and the blowovers (Table 8): the first number assumes all losses to be actual particles lost (i.e. no binder was burned off), while the second number is calculated assuming that all of the binder was burned off. For this case the binder mass was subtracted from the losses to calculate the particle losses. Where the second number is negative (as in the case of S8 pre-fired samples), the implication is that some or all of the binder was already burned off during pre-firing. The actual bed losses are likely between these two numbers.

Initial elutriation tests run in nitrogen atmospheres showed excessive elutriation losses. Disintegration of the binder in the nitrogen atmosphere was suspected, and the fluidizing gas was changed to argon. Though the elutriation losses did improve somewhat, the improvement was not dramatic. A substantial improvement was achieved though when the pellets were pre-fired at 1000° C., or pre-heated at 500° C. and 300° C. before subjecting them to the elutriation test.

The results are shown in Table 8.

TABLE 8
Elutriation losses under different conditions for fine and typical SR, and
CMC bound micro-agglomerates S8. In the last two columns, the first number
is calculated by assuming all losses to be particle losses; the second number
provides for binder losses by assuming that all of the binder was burned.

| | Atmosphere, | Initial | Final | | Bed | Blowover |
|---|---|---|---|---|---|---|
| | Pre-heat | bed mass | bed mass | Blowover | losses | losses |
| | treatment T | [g] | [g] | [g] | [%] | [%] |
| Fine SR | N₂ | 600 | 464.7 | 98.9 | 22.6 | 16.5 |
| Typical SR | N₂ | 600 | 592.8 | 1.6 | 1.20 | 0.27 |
| S8 | N₂ | 600 | 471.6 | 83.4 | 21.4/14.3 | 13.9/15.0 |
| | Ar | 580 | 446.8 | 114.4 | 23.0/15.9 | 19.7/21.2 |
| | Ar, 1000° C. | 574.3 | 536.7 | 28.0 | 6.55/<0 | 4.88/5.25 |
| | Ar, 500° C. | 600 | 577.9 | 5.8 | 3.68/<0 | 0.97/1.04 |
| | Ar, 500° C. | 600 | 587.8 | 3.5 | 2.03/<0 | 0.58/0.63 |
| | Ar, 300° C. | 600 | 580 | 7.7 | 3.33/<0 | 1.28/1.38 |

It will be seen that the best outcome, in terms of reduced elutriation or blowover, was with micro-agglomerates heat treated at 300° C. or 500° C. No heat treatment gave a poor outcome. Firing at 1000° C., while better than heat treatment, was still clearly inferior to lesser heat treatment. Firing at 1000° C. may degrade the quality of the binding webs, The results in Table 8 also suggest the benefit of heat treatment at 500° C. rather than 300° C. may be marginal and that the lower temperature is sufficient for practical and cost purposes.

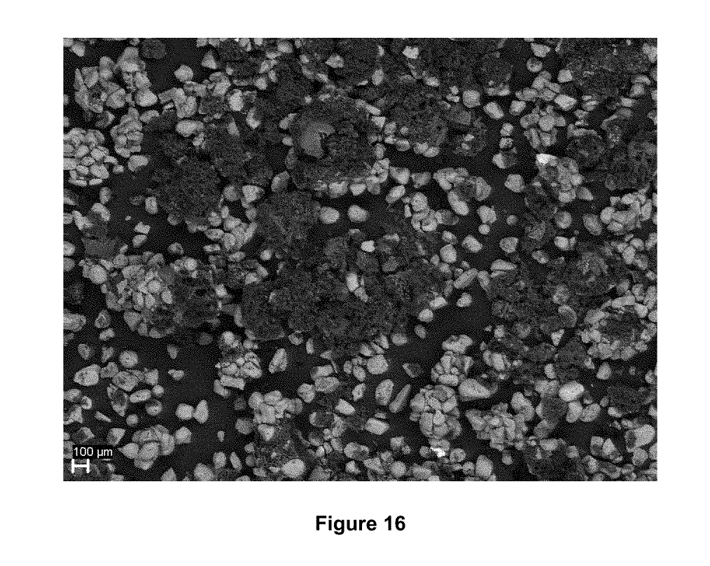

FIG. 16 is an SEM image of the last S8 sample in the above elutriation test, after heat treatment at 300° C. and before admission to the test fluidizing column.

The image shows evidence of a phase that remains linking SR particles or grains together, which phase is assumed to be the residual CMC binder following the heat treatment. Most of the SR fines particles are still agglomerated with other SR particles. The spongy masses are thought to be a sodium phase derived from the sodium CMC employed as the binder. The conclusion is that the binder is still functioning well, and this is supported by the elutriation test. Indeed, the test confirms that the heat treatment has enhanced the micro-agglomerates.

1. A micro-agglomerate of fines of a material that is predominantly titanium dioxide in which the fines are bound in the micro-agglomerate by a polysaccharide gum or cellulose derivative and in which the micro-agglomerate has been heated in the temperature range 250-600° C. so that the polysaccharide gum or cellulose derivative is an effective primary binder of the fines when the micro-agglomerate is subjected to high temperature gas flow conditions equivalent to those in the Chloride Process.

2.-3. (canceled)

4. The micro-agglomerate according to claim 1 in which each fines particle is bound to at least two other fines particles by a web of the polysaccharide gum or cellulose derivative whereby the polysaccharide gum or cellulose derivative forms a network of webbing firmly binding the particles in the micro-agglomerate.

5. The micro-agglomerate according to claim 1 wherein the webs have a respective longitudinally central region of a minimum thickness substantially smaller than the size of the respective bound fines particles, and
wherein the longitudinally central region is of a minimum thickness in the range 0.1-10 μm.

6.-9. (canceled)

10. The micro-agglomerate according to claim 1 wherein the micro-agglomerate is of a size between 125 and 5,000 μm; and/or
wherein the fines bound in the micro-agglomerates are of a size in the range 10-250 μm; and/or
wherein the proportion of polysaccharide gum or cellulose derivative is in the range 2-10% with respect to the combined weight of the fines and polysaccharide gum or cellulose derivative.

11.-13. (canceled)

14. The micro-agglomerate according to claim 1 wherein the fines comprise rutile or synthetic rutile.

15. A method of agglomerating fines of a material that is predominantly titanium dioxide, comprising:
forming the fines into micro-agglomerates in which the fines are bound in the micro-agglomerates by a polysaccharide gum or cellulose derivative, and
heating the micro-agglomerates in the temperature range 250-600° C. so that the polysaccharide gum or cellulose derivative is an effective primary binder of the fines when the micro-agglomerate is subjected to high temperature gas flow conditions equivalent to those in the Chloride Process.

16. The method according to claim 15 wherein said heating of the micro-agglomerates is in the temperature range 275-350° C. and/or the heating of the micro-agglomerates in the temperature range is for 0.1 to 2 hours.

17. (canceled)

18. The method according to claim 16, wherein, in each formed micro-agglomerate, each fines particle is bound to at least two other fines particles by a web of the polysaccharide gum or cellulose derivative whereby the polysaccharide gum or cellulose derivative forms a network of webbing firmly binding the particles in the micro-agglomerate.

19. The method according to claim 15 wherein the webs have a respective longitudinally central region of a minimum thickness substantially smaller than the size of the respective bound fines particles,
wherein the longitudinally central region is of a minimum thickness in the range 0.1-10 μm.

20.-22. (canceled)

23. The method according to claim 15 wherein the forming step is effected prior to or simultaneously with said heating in a continuous high shear mixer that combines mixing with agglomeration in a single unit.

24. The method according to claim 15 wherein the micro-agglomerates formed are of a size between 125 and 5,000 μm; and/or
wherein the fines particles bound in the micro-agglomerates are of a size in the range 10-250 μm; and/or
wherein the proportion of polysaccharide gum or cellulose derivative is in the range 2-10% with respect to the combined weight of the fines and polysaccharide gum or cellulose derivative.

25.-26. (canceled)

27. A micro-agglomerate of fines of a material that is predominantly titanium dioxide in which the fines are bound in the micro-agglomerate by webs that comprise a polysaccharide gum or a cellulose derivative, the webs having a respective longitudinally central region of a minimum thickness substantially smaller than the size of the respective bound fines particles.

28. (canceled)

29. The micro-agglomerate according to claim 27 in which each fines particle is bound to at least two other fines particles by a web of the polysaccharide gum or cellulose derivative whereby the polysaccharide gum or cellulose derivative forms a network of webbing firmly binding the particles in the micro-agglomerate.

30. The micro-agglomerate according to claim 27, wherein the longitudinally central region is of a minimum thickness in the range 0.1-10 μm.

31.-34. (canceled)

35. The micro-agglomerate according to claim 27 wherein the fines comprise rutile or synthetic rutile.

36. A method of agglomerating fines of a material that is predominantly titanium dioxide, comprising forming the fines into micro-agglomerates in which the fines are bound by webs of a polysaccharide gum or a cellulose derivative, the webs having a respective longitudinally central region of a minimum thickness substantially smaller than the size of the respective bound fines particles.

37. (canceled)

38. The method according to claim 36 wherein, in each formed micro-agglomerate, each fines particle is bound to at least two other fines particles by a web of the polysaccharide gum or cellulose derivative whereby the polysaccharide gum or cellulose derivative forms a network of webbing firmly binding the particles in the micro-agglomerate.

39. The method according to claim 36, wherein the longitudinally central region is of a minimum thickness in the range 0.1-10 μm.

40.-41. (canceled)

42. The method according to claim 36 wherein the forming step is effected prior to or simultaneously with said heating in a continuous high shear mixer that combines mixing with agglomeration in a single unit.

43. The method according to claim 36 wherein the fines comprise rutile or synthetic rutile.

44. (canceled)
